(19) United States
(12) Patent Application Publication
(10) Pub. No.: US 2011/0181542 A1
(43) Pub. Date: Jul. 28, 2011

(54) TOUCH MODULE

(75) Inventor: Yan-Mei Yang, Chiayi City (TW)

(73) Assignee: Howay Corp., Kaohsiung City (TW)

(21) Appl. No.: 12/838,550

(22) Filed: Jul. 19, 2010

(30) Foreign Application Priority Data
Jan. 28, 2010 (TW) 099201763

(51) Int. Cl. G06F 3/045

(52) U.S. Cl. 345/174

(57) ABSTRACT

A touch module includes: a sending unit disposed between a first surface of a first substrate and a second surface of a second substrate and operable to generate a sensing output in response to touching on or approaching the first substrate by a conductive object; and a control circuit unit disposed on the first surface of the substrate, exposed from the second substrate, receiving the sensing unit from the sensing unit through first and second conductive traces on the first surface of the first substrate, and operable to generate a control output based on the sensing output received thereby.

### CROSS-REFERENCE TO RELATED APPLICATION

This application claims priority of Taiwanese Application No. 099201763, filed on Jan. 28, 2010.

### BACKGROUND OF THE INVENTION

1. Field of the Invention

The invention relates to a touch module, and more particularly to a capacitive touch module.

2. Description of the Related Art

Referring to FIGS. 1 and 2, a conventional capacitive touch module is shown to include: a first substrate 11; a second substrate 12 opposite to the first substrate 11; a first electrode layer 13 formed on an top surface 111 of the first substrate 11 and formed with a plurality of spaced apart first electrode patterns 131; a second electrode layer 14 formed on a bottom surface 121 of the second substrate 12, spaced apart from the first electrode layer 13 and formed with a plurality of spaced apart second electrode patterns 141; an insulating layer 17 attached between the first and second electrode layers 13, 14; a plurality of first conductive traces 15 formed on the top surface 111 of the first substrate 11 and coupled respectively to the first electrode patterns 131; a plurality of second conductive traces 16 formed on the bottom surface 121 of the second substrate 12 and coupled respectively to the second electrode patterns 141; a control circuit 19; and a flexible double-sided ribbon cable 18 for interconnecting electrically the control circuit 19 and the first and second conductive traces 15, 16. The ribbon cable 18 is inserted between the first and second substrates 11, 12 such that terminals of the ribbon cables 181 are connected electrically and respectively to the first and second conductive traces 16, 15 by means of anisotropic conductive paste or anisotropic conductive films.

It is noted that the ribbon cable 18 has a thickness of about 100 μm, whereas the insulating layer 17 has a thickness less than 25 μm. When inserting the ribbon cable 18 between the first and second substrates 11, 12, the second substrate 12 buckles at the edge thereof, and the first conductive traces 16 may be broken as a result of edge buckling of the second substrate 12 such that production yield is adversely affected. In addition, each terminal 181 of the ribbon cable 18 should be exactly aligned with the corresponding one of the first and second conductive traces 15, 16 when inserting the ribbon cable 18 between the first and second substrates 11, 12, thereby resulting in relatively complicated assembly.

Furthermore, when the conventional capacitive touch module is applied to a handheld electronic device with a small size, the ribbon cable 18 is usually disposed adjacent to internal circuits of the electronic device. As a result, analog signals transmitted by the ribbon cable 18 are easily interfered, thereby resulting in misoperation of the control circuit 19.

### SUMMARY OF THE INVENTION

Therefore, an object of the present invention is to provide a touch module that can overcome the aforesaid disadvantages of the prior art.

According to the present invention, a touch module comprises:

a first substrate having a first surface;

a second substrate opposite to the first substrate and having a second surface that faces the first surface of the first substrate;

a trace unit formed on the first surface of the first substrate, and including a plurality of first conductive traces and a plurality of second conductive traces, each of the first and second conductive traces having an end portion covered by the second substrate;

a sensing unit disposed between the first surface of the first substrate and the second surface of the second substrate, and connected electrically to the end portions of the first and second conductive traces of the trace unit, the sensing unit being operable to generate a sensing output in response to touching on or approaching the first substrate by a conductive object; and

a control circuit unit disposed on the first surface of the first substrate, exposed from the second substrate, and coupled to the first and second conductive traces of the trace unit such that the control circuit unit receives the sensing output generated by the sensing unit through the first and second conductive traces of the trace unit, the control circuit unit being operable to generate a control output based on the sensing output received thereby.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic top view of a conventional capacitive touch module;

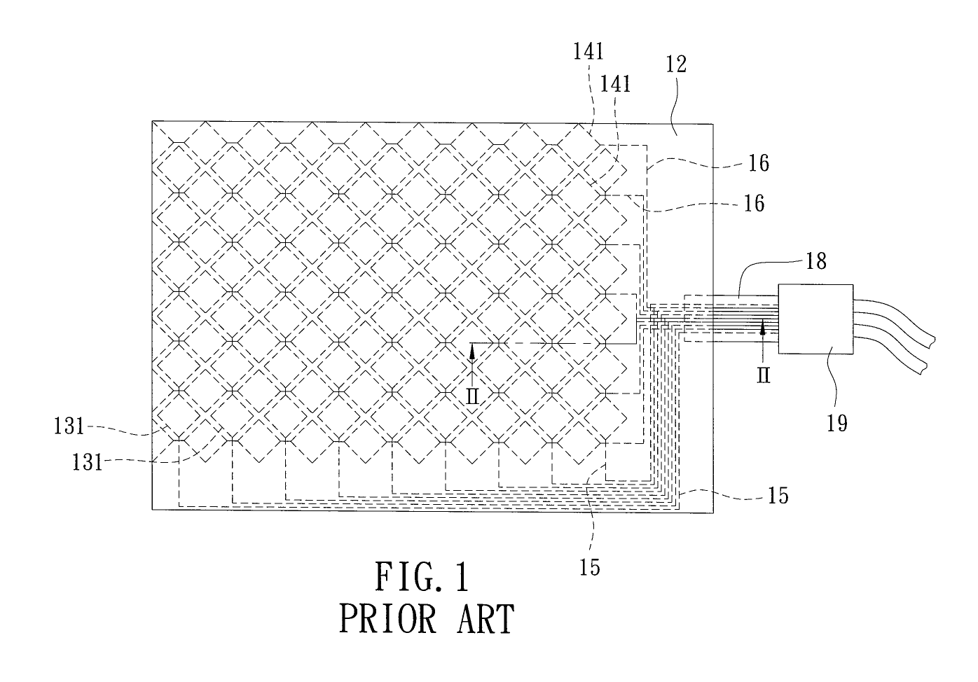

FIG. 2 is a schematic sectional view of the conventional capacitive touch module;

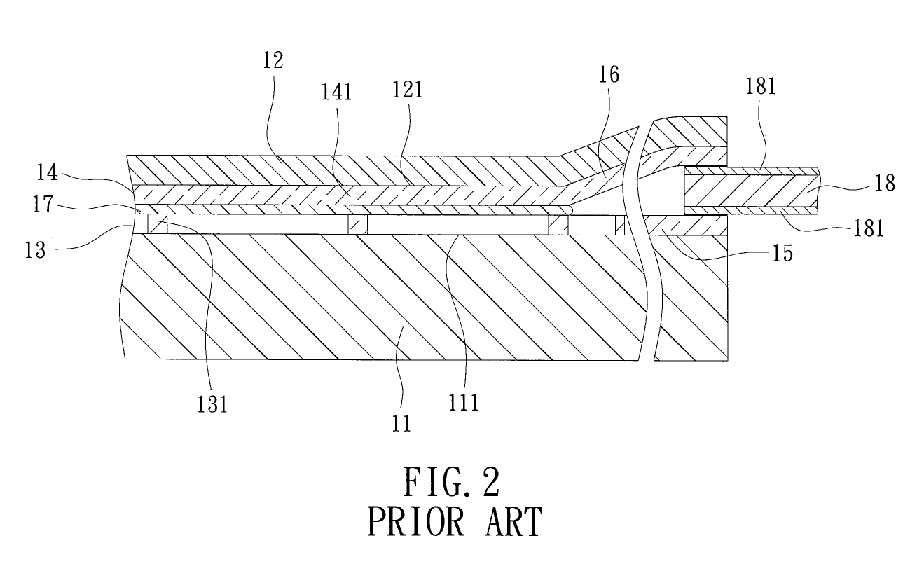

FIG. 3 is a schematic top view showing the first preferred embodiment of a touch module according to the present invention;

FIG. 4 is a fragmentary schematic sectional view of the first preferred embodiment taken along line IV-IV in FIG. 3;

FIG. 5 is a schematic sectional view of the first preferred embodiment taken along line V-V in FIG. 3;

FIG. 6 is a schematic top view showing an application of the first preferred embodiment;

FIG. 7 is a schematic top view showing the second preferred embodiment of a touch module according to the present invention;

FIG. 8 is a schematic top view showing the third preferred embodiment of a touch module according to the present invention;

FIG. 9 is a fragmentary schematic sectional view of the third preferred embodiment taken along line IX-IX in FIG. 8;

FIG. 10 is a fragmentary schematic section view showing a variation of the third preferred embodiment; and

FIG. 11 is a fragmentary schematic section view showing the fourth preferred embodiment of a touch module according to the present invention.

### DETAILED DESCRIPTION OF THE PREFERRED EMBODIMENTS

Before the present invention is described in greater detail, it should be noted that like elements are denoted by the same reference numerals throughout the disclosure.

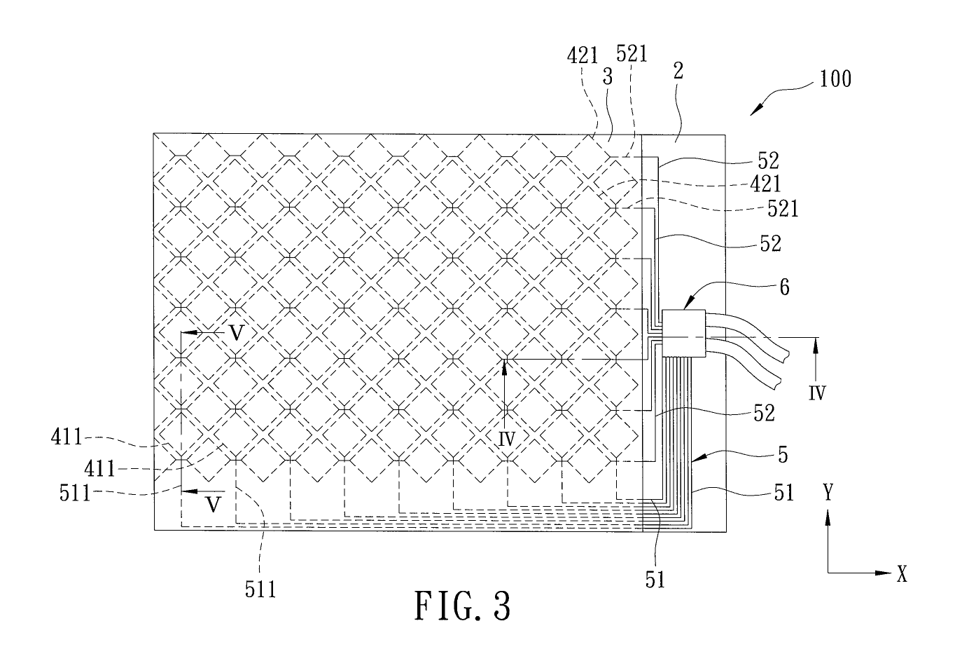

Referring to FIGS. 3 to 5, the first preferred embodiment of a touch module 100 according to the present invention is shown to include a first substrate 2, a second substrate 3, a trace unit 5, a sensing unit 4, and a control circuit unit 6. The touch module 100 is a capacitive touch module.

The first substrate 2 has a first surface 21. The second substrate 3 is opposite to the first substrate 2, and has a second surface 31 that faces the first surface 21 of the first substrate 2. In this embodiment, each of the first and second substrates 2, 3 is made from a transparent material. When the touch module 100 is applied to an electronic device (not shown), one of the first and second substrates 2, 3 can serve as a housing part of the electronic device.

The trace unit 5 is formed on the first surface 21 of the first substrate 2, and includes a plurality of first conductive traces 51 and a plurality of second conductive traces 52. Each of the first and second conductive traces 51, 52 has an end portion 511, 521 covered by the second substrate 3. In this embodiment, each of the first and second conductive traces 51, 52 is made from a transparent conductive material, such as indium tin oxide (ITO) or zinc oxide (ZnO).

The sensing unit 4 is disposed between the first surface 21 of the first substrate 2 and the second surface 31 of the second substrate 3, and is connected electrically to the end portions 511, 521 of the first and second conductive traces 51, 52 of the trace unit 5. The sensing unit 4 is of capacitive sensing, and is operable to generate a sensing output, such as an analog signal, in response to touch on or approaching the first substrate 2 by a conductive object, such as a user's finger. In this embodiment, the sensing unit 4 includes first and second electrode layers 41, 42, an insulating layer 43, and a plurality of conducting sections 44.

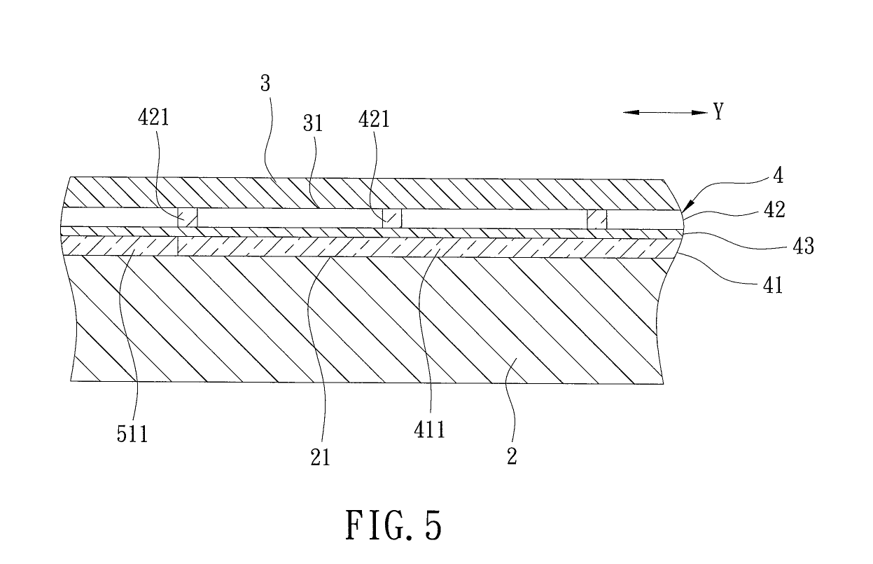

The first electrode layer 41 is formed on the first surface 21 of the first substrate 2, and is formed with a plurality of first electrode patterns 411 extending in a longitudinal direction (Y), spaced apart from each other in a transverse direction (X) that is transverse to the longitudinal direction (Y), and coupled respectively to the end portions 511 of the first conductive traces 51 of the trace unit 5, as shown in FIG. 5. In this embodiment, each first electrode pattern 411 includes a plurality of alternately arranged rhombic sections and linear sections (see FIG. 3). The second electrode layer 42 is formed on the second surface 31 of the second substrate 3, and is spaced apart from the first electrode layer 41. The second electrode layer 42 is formed with a plurality of second electrode patterns 421 extending in the transverse direction (X) and spaced apart from each other in the longitudinal direction (Y). In this embodiment, each second electrode pattern 421 is similar to the first electrode patterns 411, and includes alternately arrange rhombic sections and linear sections (see FIG. 3). In addition, each of the first and second electrode layers 41, 42 is made from a transparent conductive material, such as ITO or ZnO.

The insulating layer 43 is formed between the first and second electrode layers 41, 42 for spacing the first electrode layer 41 apart from the second electrode layer 42. In this embodiment, the insulating layer 43 is made from a transparent insulating material, such as transparent plastic, a transparent adhesive or glass.

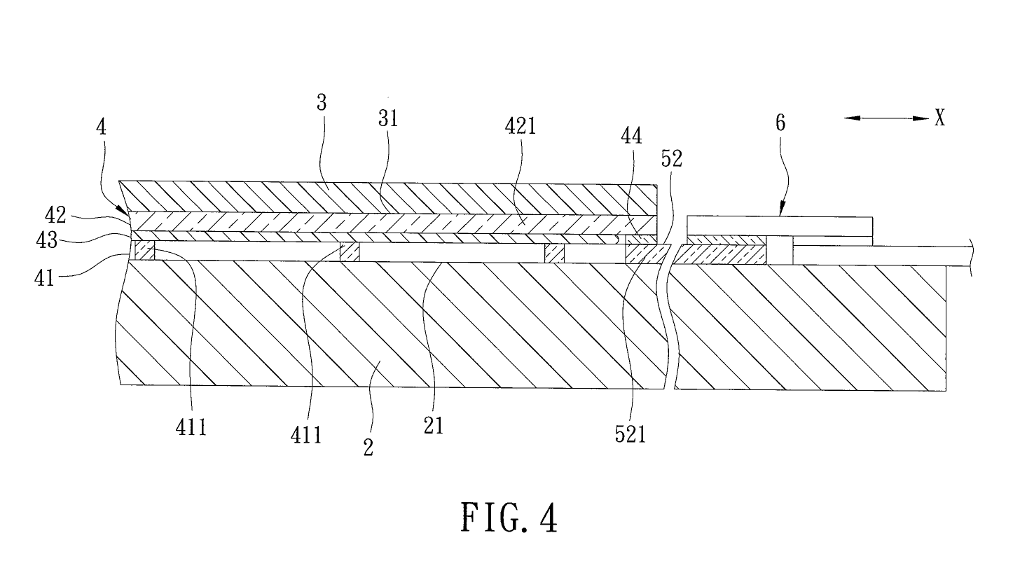

The conducting sections 44 are disposed between the first and second electrode layers 41, 42. Each conducting section 44 interconnects electrically a corresponding second electrode pattern 421 and the end portion 521 of a corresponding second conductive trace 52 of the trace unit 5, as shown in FIG. 4. In this embodiment, the conducting sections 44 are made from a transparent conductive material, such as ITO or ZnO. In addition, each conducting section 44 is attached between the corresponding second electrode pattern 421 and the end portion 521 of the corresponding second conductive trace 52 of the trace unit 5 by means of one of a conductive adhesive and an anisotropic conductive film.

The control circuit unit 6 is disposed on the first surface 21 of the first substrate 2, is exposed from the second substrate 3, and is coupled to the first and second conductive traces 51, 52 of the trace unit 5 such that the control circuit unit 6 receives the sensing output generated by the sensing unit 4 through the first and second conductive traces 51, 52 of the trace unit 5. The control circuit unit 6 is operable to generate a control output, such as a digital signal, based on the sensing output received thereby. In this embodiment, the control circuit unit 6 is in the form of a single control chip, and is mounted on the first surface 21 of the first substrate 2 by one of chip-on-glass (COG) process and chip-on-film (COF) process so as to connect electrically the first and second conductive traces 51, 52 of the trace unit 5.

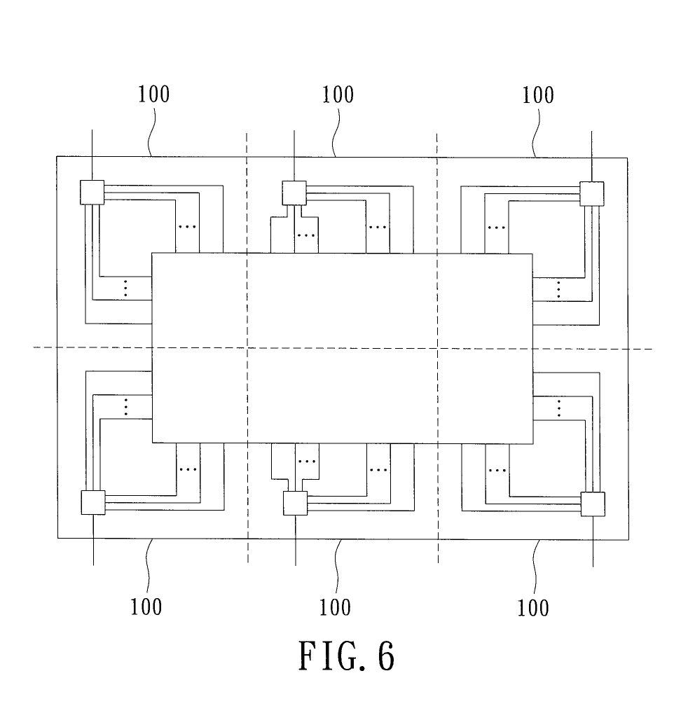

FIG. 6 illustrates an application of the touch module 100 of the first preferred embodiment, wherein a plurality of the touch modules 100 are integrated into a single touch module with a larger size and reduced interference.

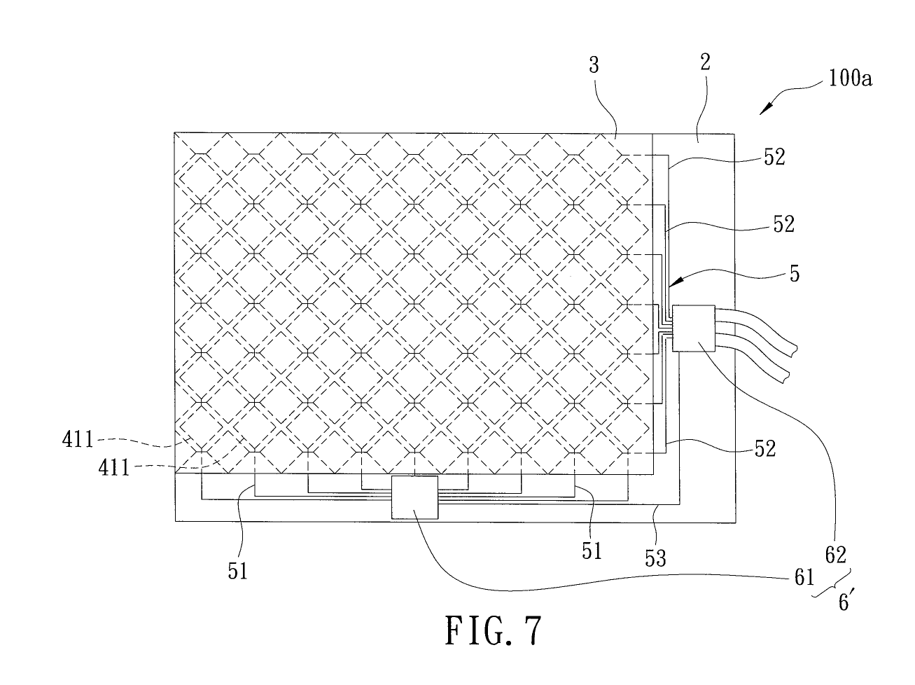

FIG. 7 illustrates the second preferred embodiment of a touch module (100a) according to this invention, which is a modification of the first preferred embodiment. In this embodiment, the control circuit unit 6′ includes first and second circuit chips 61, 62. The first circuit chip 61 is connected electrically to the first conductive traces 51 of the trace unit 5, and is mounted on the first surface 21 of the first substrate 2 by one of COG process and COF process so as to connect electrically to the first conductive traces 51. The second circuit chip 62 is connected electrically to the second conductive traces 52 of the trace unit 5, and is coupled wiredly to the first control chip 61. The second control chip 62 is operable to generate the control output. In addition, the trace unit further includes a transmission trace 53 interconnects electrically the first and second control chips 61, 62. In such a configuration, the first conductive traces 51 have a shorter length as compared to the first conductive traces 51 of the first preferred embodiment shown in FIG. 3. Therefore, when transmitting analog signals through the first conductive traces 51, interference can be reduced.

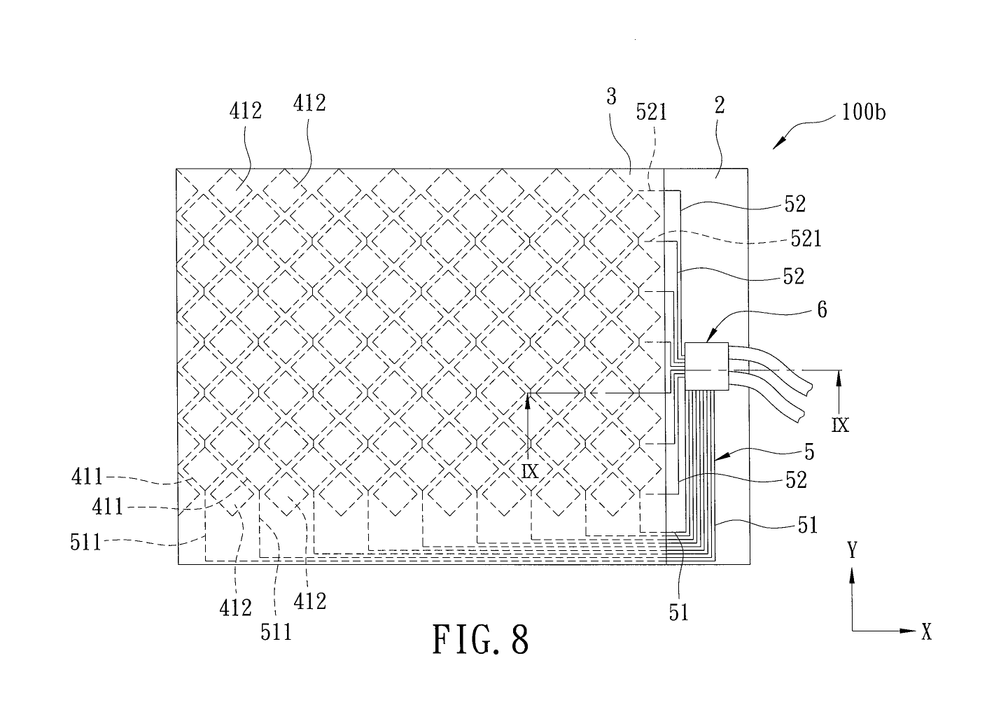

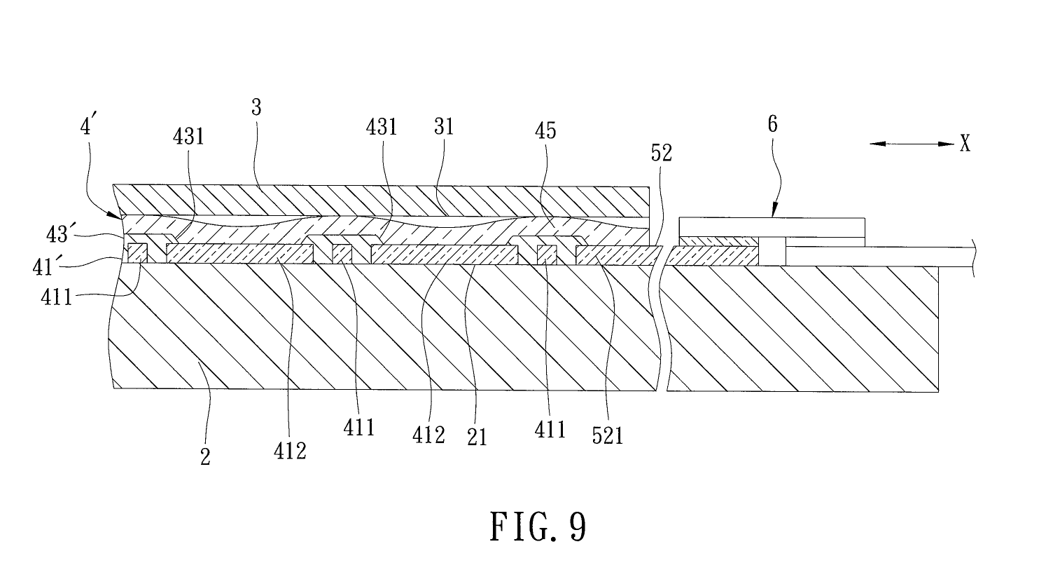

FIGS. 8 and 9 illustrate the third preferred embodiment of a touch module (100b) according to this invention, which is a modification of the first preferred embodiment. In this embodiment, the sensing unit 4′ includes an electrode layer 41′, an insulating layer 43′, and a plurality of bridging members 45.

The electrode layer 41′ is formed on the first surface 21 of the first substrate 2, and is formed with a plurality of spaced apart first electrode patterns 411, and a plurality of spaced apart electrode units. The first electrode patterns 411 are identical to those of the first preferred embodiment. The electrode units are arranged in the longitudinal direction (Y). Each electrode unit is spaced apart from the first electrode patterns 411, and includes a plurality of spaced apart second electrode patterns 412 arranged in the transverse direction (X).

The insulating layer 43′ is formed on the electrode layer 41′ for covering entirely the first electrode patterns 411. The insulating layer 43′ is formed with a plurality of through holes 431 corresponding respectively to the second electrode patterns 412 of the electrode units such that said second electrode patterns 412 are exposed from the insulating layer 43′ through the through holes 431. In this embodiment, the insulating layer 43′ is made from a transparent insulating material, such as transparent plastic, a transparent adhesive or glass.

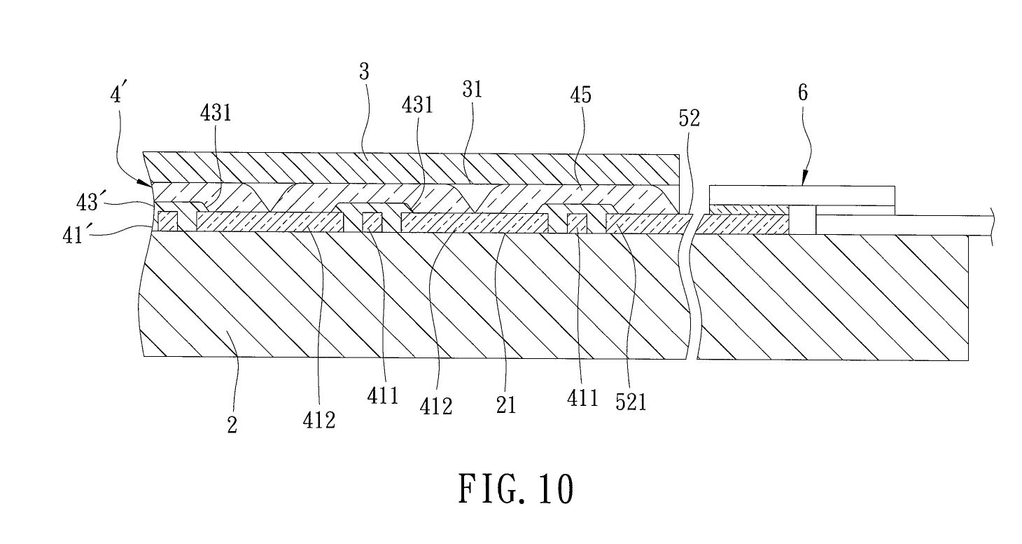

The bridging members 45 are formed between the insulating layer 43′ and the second surface 31 of the second substrate 3, and are coupled respectively to the end portions 521 of the second conductive traces 52 of the trace unit 5. Each bridging member 45 extends in the transverse direction (X) across the first electrode patterns 411, and is spaced apart from the first electrode patterns 411 by the insulating layer 43′. Each bridging member 45 further extends into corresponding through holes 431 in the insulating layer 43′ so as to contact electrically the second electrode patterns 412 of the corresponding one of the electrode units, as shown in FIG. 9. The bridging members 45 are made from a transparent conductive material. In this embodiment, each bridging member 45 fills the corresponding through holes 431 in the insulating layer 43′. Alternatively, as shown in FIG. 10, each bridging member 45 partly fills the corresponding through holes 431 in the insulating layer 43′.

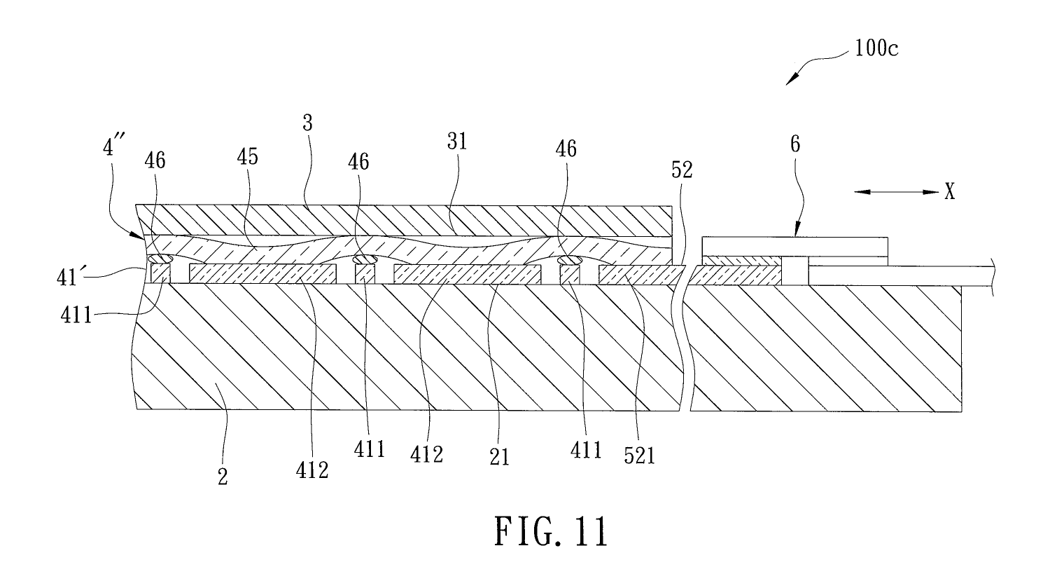

FIG. 11 illustrates the fourth preferred embodiment of a touch module (100c) according to this invention, which is a modification of the third preferred embodiment. As compared to the third preferred embodiment, the insulating layer 431′ is dispensed with. In this embodiment, the sensing unit 4″ further includes a plurality of spacing units that are used as a substitute for the insulating layer 43′ of the third preferred embodiment. Each spacing unit is formed on a corresponding first electrode pattern 411, and includes a plurality of spaced apart insulating pads 46, each of which is disposed between a corresponding bridging member 45 and the corresponding first electrode pattern 411 to thereby space the corresponding bridging member 45 apart from the corresponding first electrode pattern 411. In this embodiment, the insulating pads 46 are made from a transparent insulating material.

In sum, since the control circuit unit 6 is mounted on the first surface 21 of the first substrate, the control circuit unit 6 is connected electrically to the sensing unit 4, 4′, 4″ through the first and second conductive traces 51, 52 of the trace unit 5 without the ribbon cable 18 of the aforesaid conventional capacitive touch module. Thus, edge buckling encountered in the aforesaid conventional capacitive touch module can be avoided, thereby reducing interference during transmission. As a result, the touch module 100, (100a), (100b), (100c) of the present invention can be easily assembled and can be fabricated with enhanced production yield. On the other hand, the first and second substrates 2, 3 and the control circuit unit 6, 6′ can be configured so that the touch module 100, (100a), (100b), (100c) of the present invention can be applied to various electronic devices with different size specifications with minimized interference.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A touch module comprising:
a first substrate having a first surface;
a second substrate opposite to said first substrate and having a second surface that faces said first surface of said first substrate;
a trace unit formed on said first surface of said first substrate, and including a plurality of first conductive traces and a plurality of second conductive traces, each of said first and second conductive traces having an end portion covered by said second substrate;
a sensing unit disposed between said first surface of said first substrate and said second surface of said second substrate, and connected electrically to said end portions of said first and second conductive traces of said trace unit, said sensing unit being operable to generate a sensing output in response to touching on or approaching said first substrate by a conductive object; and
a control circuit unit disposed on said first surface of said first substrate, exposed from said second substrate, and coupled to said first and second conductive traces of said trace unit such that said control circuit unit receives the sensing output generated by said sensing unit through said first and second conductive traces of said trace unit, said control circuit unit being operable to generate a control output based on the sensing output received thereby.

2. The touch module as claimed in claim 1, wherein said control circuit unit is in the form of a single control chip.

3. The touch module as claimed in claim 2, wherein said single control chip is mounted on said first surface of said first substrate by one of chip-on-glass process and chip-on-film process.

4. The touch module as claimed in claim 1, wherein said control circuit unit includes:
a first control chip mounted on said first surface of said first substrate and connected electrically to said first conductive traces of said trace unit; and
a second control chip mounted on said first surface of said first substrate and connected electrically to said second conductive traces of said trace unit and coupled wiredly to said first control chip, said second control chip being operable to generate the control output.

5. The touch module as claimed in claim 4, wherein said trace unit 5 further includes a transmission trace interconnecting electrically said first and second control chips.

6. The touch module as claimed in claim 1, wherein said sensing unit is of capacitive sensing.

7. The touch module as claimed claim 1, wherein:
said sensing unit includes spaced apart first and second electrode layers formed respectively on said first surface of said first substrate and said second surface of said second substrate;
said first electrode layer is formed with a plurality of first electrode patterns extending in a longitudinal direction and spaced apart from each other in a transverse direction that is transverse to the longitudinal direction, each of said first electrode patterns being coupled to said end portion of a corresponding one of said first conductive traces of said trace unit; and
said second electrode layer is formed with a plurality of second electrode patterns extending in the transverse direction and spaced apart from each other in the longitudinal direction, each of said second electrode patterns overlapping and being connected electrically to said end portion of a corresponding one of said second conductive traces of said trace unit.

8. The touch module as claimed in claim 7, wherein said sensing unit further includes:
an insulating layer formed between said first and second electrode layers for spacing said first electrode layer apart from said second electrode layer; and
a plurality of conducting sections disposed between said first and second electrode layers, each of said conducting sections interconnecting electrically a corresponding one of said second electrode patterns and said end portion of a corresponding one of said second conductive traces of said trace unit.

9. The touch module as claimed in claim 8, wherein said insulating layer is made from a transparent insulating material.

10. The touch module as claimed in claim 9, wherein said transparent insulating material is one of transparent plastic, a transparent adhesive and glass.

11. The touch module as claimed in claim 8, wherein each of said first and second electrode layers, said conducting sections, and said first and second conductive traces is made from a transparent conductive material.

12. The touch module as claimed in claim 11, wherein said transparent conductive material is one of indium tin oxide and zinc oxide.

13. The touch module as claimed in claim 8, wherein each of said conducting sections is attached between the corresponding one of said second electrode patterns and said end portion of the corresponding one of said second conductive traces of said trace unit by means of one of a conductive adhesive and an anisotropic conductive film.

14. The touch module as claimed in claim 1, wherein said sensing unit includes:
an electrode layer formed on said first surface of said first substrate, and formed with a plurality of spaced apart first electrode patterns each extending in a longitudinal direction and coupled to said end portion of a corresponding one of said first conductive traces of said trace unit, and a plurality of spaced apart electrode units arranged in the longitudinal direction, each of said electrode units being spaced apart from said first electrode patterns and including a plurality of spaced apart second electrode patterns arranged in a transverse direction transverse to the longitudinal direction; and
a plurality of bridging members formed between said electrode layer and said second surface of said second substrate and coupled respectively to said end portions of said second conductive traces of said trace unit, each of said bridging members extending in the transverse direction across said first electrode patterns, being spaced apart from said first electrode patterns, and being in electrical contact with said second electrode patterns of a corresponding one of said electrode units.

15. The touch module as claimed in claim 14, wherein each of said bridging members is made from a transparent conductive material.

16. The touch module as claimed in claim 14, wherein said sensing unit further includes an insulating layer formed on said electrode layer for covering entirely said first electrode patterns, and formed with a plurality of through holes corresponding respectively to said second electrode patterns of said electrode units such that each of said bridging members extends into corresponding ones of said through holes in said insulating layer to contact electrically said second electrode patterns of the corresponding one of said electrode units.

17. The touch module as claimed in claim 16, wherein said insulating layer is made from a transparent insulating material.

18. The touch module as claimed in claim 14, wherein said sensing unit further includes a plurality of spacing unit each formed on a corresponding one of said first electrode patterns, each of said spacing units including a plurality of spaced apart insulating pads each disposed between a corresponding one of said bridging members and the corresponding one of said first electrode patterns to thereby space the corresponding one of said bridging members apart from the corresponding one of said first electrode patterns.

19. The touch module as claimed in claim 18, wherein each of said insulating pads is made from a transparent insulating material.

20. The touch module as claimed in claim 1, wherein each of said first and second substrates is made from a transparent material.
